(19) United States
(12) Patent Application Publication
(10) Pub. No.: US 2013/0285572 A1
(43) Pub. Date: Oct. 31, 2013

(54) LED DRIVER CIRCUIT AND METHOD

(71) Applicant: Marc Saes, Eindhoven (NL)

(72) Inventor: Marc Saes, Eindhoven (NL)

(73) Assignee: ELDOLAB HOLDING B.V., Eindhoven (NL)

(21) Appl. No.: 13/821,057

(22) PCT Filed: Sep. 12, 2011
(86) PCT No.: PCT/NL2011/050621

§ 371 Date: May 23, 2013

Related U.S. Application Data
(60) Provisional application No. 61/381,572, filed on Sep. 10, 2010.

(51) Int. Cl. H05B 33/08

(52) U.S. Cl. CPC H05B 33/0842
USPC 315/297

(57) ABSTRACT

A driver circuit for driving at least one LED includes a data input for receiving set point data at a first data rate and at a first bit resolution, an LED output for driving the at least one LED with LED driving values at a second data rate and at a second bit resolution, and a processing device arranged for determining from the set point data by interpolation at least part of the LED driving values. The second data rate is higher than the first data rate, the processing device being arranged to interpolate in time.

### CROSS-REFERENCE TO RELATED APPLICATIONS

This application is the National Stage of International Application No. PCT/NL2011/050621, filed Sep. 12, 2011, which claims the benefit of U.S. Provisional Application No. 61/381,572, filed Sep. 10, 2010, the contents of which is incorporated by reference herein.

### FIELD OF THE INVENTION

The invention relates to a driver circuit for driving at least one LED, an LED light fixture comprising such driver circuit and a method for driving at least one LED.

### BACKGROUND OF THE INVENTION

At present, light emitting diodes (hereinafter abbreviated as LEDs) are applied for illumination purposes due to for example their high energy efficiency, ability to produce different colors by mixing of for example blue, red, green and white LEDs, dimmability, compact dimensions or for other reasons. This trend is supported by the increasing availability of high power LED's at relatively low cost. In order to drive the LED's, use may be made of a driver circuit, that may include a controller that controls an intensity of the or each LED by means of duty cycling, pulse width modulation, pulsation, LED current control or others or any combination thereof. Furthermore, a current source or similar circuit may be comprised in the drive circuit. In order to drive the LEDs at a variety of colors, intensity, etc, use may be made of a digital communication network, such as a DMX network, that communicates data to one or more drivers. Commonly, a sequence of data is provided via the network to the driver in order to provide information regarding for example intensity, color, etc to the driver circuit.

Current solutions for driving LEDs have difficulties in controlling the LED's current in such a way that the intensity of the radiated light changes in a smooth way as perceived by humans when the intensity set-point is changed. Causes are a.o. the network bandwidth through which set-points arrive at the driver circuit combined with a certain size of changes between sequential set-points but can also be the speed and step size of set-points as provided by directly connected human interfaces (such as a dimming wheel control). The same inability to achieve smoothness is often present when changing color.

A typical example is a LED driver circuit (the driver circuit may in this document also be referred to as driver) that is connected through a DMX network where new set-points for a LED may arrive at 23 ms distances in a network with 512 channels and 8 bit set-points. When the stepsize between 2 such neighbouring set-points is more than 1% of the light intensity, typical humans perceive this as a brightness discontinuity. On the other hand, certain steep brightness changes are desired. Achieving those steep changes may, using a current data network typically only be done using step sizes larger than 1% of the current brightness.

The result may be that humans may perceive discontinuities in the light's intensity or color.

To aggravate the situation, today higher demands are made with respect to resolution, contrast and update rate of the set-points as applications are broadening to “very low light”, “very dynamic”, “very low light as well as very bright light in 1 system” and video situations.

Also the number of channels used tends to increase.

These demands lead to higher stepsizes between 2 consecutive set-points, wider set-points (e.g. 32 or 16 in stead of 8 bits), higher set-point rates, multiple in stead of 1 frames to be sent to transfer the set-points for all channels, etcetera.

As an example, 16 bit set-points in a DMX network system would mean that the number of channels is either halved or, when insisting on 512 channels, that 2 frames are needed which increases inter set-point time to at least 46 milliseconds (not counting the interframe delay).

Another disadvantage of todays systems arises in video systems where synchronization issues arise when setpoints for pixels that belong to a video frame at time T are sent sequentially in time. The increasing delay per pixel causes visual effects in the picture finally shown to the user (for example an oblique line may appear to be a series of isolated dots on screen). Different delay sizes can occur depending on the network type. In DMX for example the distance between channel set-points within a frame differs from the extra delay that will occur between the last set-point in a current frame with respect to the first set-point in the successor frame.

Also most contemporary solutions support a LED current on/off rate that is in the range of 50 to 200 Hertz. For video applications however this is insufficient, as video frames may capture only light during OFF periods, or may have variations in the average light captured due to ON/OFF times that are to large percentage-wise in comparison to the video frame time. A LED duty cycle rate of more than about 300 Hertz may be required. The variations mentioned in this paragraph are noticeable in the video picture and are therefore a disadvantage of current systems.

### SUMMARY OF THE INVENTION

A goal of the invention is to solve or at least alleviate one or more of the above problems.

Thereto, the driver circuit according to the invention comprises a data input for receiving set point data at a first data rate and at a first bit resolution, an LED output for driving the at least one LED with LED driving values at a second data rate and at a second bit resolution, and a processing device arranged for determining from the set point data by interpolation at least part of the LED driving values.

The data input may be formed by a data network interface, such as a DMX bus interface or any other suitable data input. The data provided at the data input may come from any data source, such as a DMX controller, a dimmer, etc. The driver circuit may be arranged for driving one LED or a plurality of LEDs, for example arranged in groups (such as groups each having a different color). The setpoint data may be provided in any form, it may or example be provided as a bit stream or as separate datapackets, at a constant data rate or in bursts, synchronously or asynchronously, etc. The processing device may comprise any data processing device. It may be formed by a programmable device, such as a microcontroller, microprocessor, embedded controller, digital signal processor, etc, provided with suitable software instructions so as to perform an interpolation, or by any kind of dedicated electronic hardware that is arranged to perform an interpolation.

By means of the interpolation, a resolution of the LED irradiation as observed by an eye of a human observer or by a camera or other sensor, may be increased, so that a more smooth dimming and/or transient behavior may be provided. On the other hand, giving a certain resolution of the driving of the at least one LED, a lower data rate and/or a lower resolution of the setpoint values may suffice, so that more drivers may be driven—given a certain network capacity—by the same network or other data transmission means, or so that use may be made of a network or other data transmission means that operates at a lower data rate, thereby potentially reducing power consumption, wiring and cost.

The term interpolation may be understood so as to comprise any kind of interpolation, including linear, predictive, etc.

In order to increase a data rate of the LED drive values, the second data rate may be higher than the first data rate, the processing device being arranged to interpolate in time.

In order to increase a bit resolution for the LED drive values, the second bit resolution may be higher than the first bit resolution, the processing device being arranged to interpolate in bit resolution. The bit resolution may be represented in any way, e.g. by means of a digital representation, an analogue representation, etc.

The processing device may be arranged to, in response to a receiving of a setpoint data, determine a target driving value from the received setpoint data, to determine a slope from the received setpoint data, a previous setpoint data, and an elapsed time between the received setpoint data and the previous setpoint data, and to determine following LED driving values in accordance with the slope and the target driving value. Thereby, rate of a change of the setpoint over time between two successive setpoints is taken as a basis to determine at what rate the processing device brings the LED driving values towards the target driving value. The stope may be a linear slope or follow any curved or other profile. By means of this embodiment, a fast to implement, stable and mostly low error interpolation may be provided.

In an embodiment, the processing device is arranged to determine the target driving value in correspondence with the set point data. Thereby, the interpolation is performed retrospectively, taking a value that corresponds to the latest received setpoint data as a target, so as to mostly avoid overshoot or similar effects. Having determined a slope, the processing device may with a low processing load determine the following LED driving values so as to follow the slope towards the target driving value. The slope may be measured against multiple reference time events. Amongst others the slope can be measured against a real-time clock, by counting the number of times a set-point from the network is received (network update) or by counting the number of times an output frame update is done.

To cope with relatively fast changes, the processing device may be arranged to further determine if the slope exceeds a predetermined threshold, and if this is the case, to set a next following driving value to the target driving value. Thereby, errors that may occur in case the interpolation would delay a reaching of the target value—in case of relatively fast changes, may be reduced. In case of relatively fast changes, steps in the LED driving value may be less noticeable to a user, camera, etc, hence reducing a need for interpolation. The threshold may for example be set to a rate of change whereby two successive setpoints differs from the previous one by at least one bit.

To allow a fast adaptation to a further setpoint, before the target value of the present setpoint has been reached, the processing device may be arranged to, when a following setpoint data is received at the data input before the target driving value has been reached, to determine a following target driving value from the following setpoint data, to determine a following slope from the following target driving value, a presently reached LED driving value and an elapsed time between the following setpoint data and the received setpoint data, and to determine following LED driving values in accordance with the following slope towards the following target driving value.

Instead of or in addition to the above described ways of interpolation, the processing device may be arranged to, in response to the receiving of the setpoint data, predict the target driving value from the received setpoint data and at least one previously received setpoint data, and to determine following LED driving values in accordance with the predicted target driving value. The prediction may allow to reduce a delay that may occur with the above described ways of interpolation.

The predicting may comprise a linear prediction so as to allow a calculation of the predicted LED driving values at a relatively low processing load.

An improved matching (low average interpolation error) may be achieved in case the predicting comprises a finite impulse response filter prediction.

In order to reduce an effect of predicting in a wrong direction, in case of a sudden change in the direction of the change of the setpoint values, the processing device may be arranged to detect if a direction of a value of a latest received setpoint data changes in respect of a direction of values of previously received successive setpoint data, and if this is the case, to calculate the target value from the latest received setpoint data and to interpolate along a line between an actual led driving value and the target value.

A low total error may be achieved by a combination of retrospective interpolation and prediction, which may for example be achieved by the processing device being arranged to set the target driving value between the target driving value as determined from the predicting and the target driving value as determined in correspondence with the received setpoint data.

The invention further comprises a LED light fixture comprising the driver circuit in accordance with the invention.

A smooth dimming behavior over a wide range of applications may be achieved as described below, which may comprise a combination of elements as described above.

Assume that the first data rate with which the setpoints are provided is generally lower than the second data rate with which the LED driving values are provided to the LEDs and that the resolution of the LED driving values in generally higher than the resolution of the setpoint values (i.e. setpoint data). The process comprises the following steps:

A time between changes of the value of the setpoint data is measured. Thereto, the processing device may be arranged to initialize a counter when a setpoint having a changed value is received, to periodically increment the counter so as to measure a the time, as long as the received setpoint data remains at the same value, and to store a value of the counter in a working memory of the processing device upon receipt of a setpoint data having a different value. Using the measured time during which the received setpoint data had the same value, and the value of the last received setpoint data, an interpolation slope is determined, for example in terms of an interpolation increment step size, the LED driving value then being interpolated (e.g. from its present value or from a previous setpoint) towards the new setpoint.

In other words, the driver circuit, or more specifically the processing device being arranged to
compare a value of a received setpoint with a value of a previously received setpoint,
increment an elapsed time measurement counter when the value of the received setpoint is the same as the value of the previously received setpoint,
repeat the compare and increment until the value of the received setpoint is different from the value of the previously received setpoint,
store a value of the elapsed time measurement counter in a memory of the processing device (and possibly reset the elapsed time measurement counter to a begin value, such as zero),
determine an interpolation slope from the received setpoint data (and for example a present LED driving value or previous value of the setpoint data) and the value of the elapsed time measurement counter as stored in the memory, and
interpolate following LED driving values in accordance with the slope.

The processing device may be arranged to increment the value of the elapsed time measurement counter upon each issue of a LED driving value, so that the time is measured in terms of the LED driving value data rate (i.e. the second data rate), which may be an accurate and stable data rate, as it may be set by the driving circuit itself.

As a result, the interpolation may adapt to a variety of situations: For example, a repetition rate of the setpoint values may strongly vary from situation to situation. For example, in a bus, such as a DMX bus, may apply an overall maximum data rate for all LED channels driven by that bus together. Hence, the more channels are to be driven by one bus, the lower a setpoint data rate per LED channel may be, thus the longer a time period between successive setpoints for a specific channel. As a time between receipt of changes in the setpoint values is measured, the described embodiment allows to take account of such variation and may adapt a number of interpolation steps, increment size per step, etc to the setpoint data rate and/or to a desired led driving value data rate.

The data rate with which the setpoints are received may be asynchronous with the data rate with which a light show has been set up. For example, a light show may have been generated as a sequence of setpoints at a first data rate, while a characteristic of a databus that connects the LED driving circuit, requires a transmission of data at a second, different data rate, which may result in aliasing effects. Aliasing or like effects may be effectively reduced by an averaging of received setpoint data, prior to the interpolation of the (thus averaged) setpoint data. The interpolation thus being performed using the averaged setpoint data. Any type of averaging may be applied, for example a moving average filter. In an embodiment, the averaging comprises averaging the received setpoint data and one previously received setpoint data: hence, an effective averaging may be performed while at the same time having a low impact on processing capacity of the processing device and on a dynamic behavior of the obtained LED intensity profile (light show) over time.

The processing device may be arranged to compare a difference between the received setpoint data and the previously received setpoint data with a predetermined threshold and in case the difference exceeds the threshold, to interpolate the LED driving value from its present value to a value corresponding with the received setpoint data in a time period substantially equal to the time period between receipt of two successive setpoint data.

Thereby, in case of large or relatively fast changes, instead of applying the measured, counted time value, the LED driving value is interpolated to the new setpoint within a shorter time, allowing to quickly follow the received setpoint values in a situation where additional interpolation steps would hardly or not be noticeable to a human observer.

Furthermore, in case of a slow change, whereby the processing device detects that a predetermined number of successive setpoint data has a same value, i.e. the processing device being arranged to, if the value of the elapsed time measurement counter exceeds a predetermined maximum value, upon receipt of an incremented or decremented setpoint data following successive setpoint data having the same value, store in the memory the predetermined maximum value in stead of the elapsed time measurement value, and interpolate the LED driving value to a value corresponding with the incremented or decremented setpoint data within a time period derived from the predetermined maximum value.

As a human eye may be relatively insensitive to a slow speed of change of small increments or decrements, an added benefit of an extremely slow, gradual rise may be little or none at all, hence may be avoided in such cases, by setting a limit to the time within which the driver circuit interpolates to the new setpoint.

It is noted that with the above described adaptive, smooth interpolation, a wide variety of operating conditions (fast or slow setpoint data rate, fast or slow increments, etc.) may be handled, Hence, little or no configuration parameters are to be set in order to provide an adequate, smooth dimming behavior. In particular when the averaging of (two) setpoint values is applied as described above, it may for example suffice to enable or disable the interpolation by a suitable configuration parameter.

It is noted that the interpolation as described in this document may be applied with setpoint data representing a linear setpoint as well as with logarithmic setpoint data. In case of logarithmic setpoint data, if for example 8 bits (256 values) are applied, each incremental step of 1 bit is observed by a human as having a similar incremental effect.

Still further, the processing device may be arranged to proceed to prediction when a LED driving value corresponding with the last received setpoint data has been reached, and no new setpoint data is received. Thereby, in case setpoint data is interrupted for any reason, prediction may be applied.

The same or similar effects as described above with reference to the driver circuit according to the invention, may also be achieved by a method for driving at least one LED, comprising:
receiving by a data input of a driver circuit, set point data at a first data rate and at a first bit resolution,
driving by means of an LED output of the driver circuit the at least one LED with LED driving values at a second data rate and at a second bit resolution, and
   wherein at least part of the LED driving values is determined from the set point data by interpolation by a processing device of the driver circuit.

The same or similar embodiments as described above with reference to the driving circuit according to the invention, may also apply to the method according to the invention, thereby achieving same or similar effects as described with reference to the driver circuit according to the invention.

### BRIEF DESCRIPTION OF THE DRAWINGS

Further advantages and features of the invention will become clear from the appended drawings and corresponding description, wherein a non limiting embodiment of the invention is shown, wherein:

FIG. 1 depicts a time diagram of setpoint data and LED driving values;

FIGS. 2A and 2B depict time diagrams of LED driving values;

FIG. 3 depicts another time diagram of LED driving values;

FIGS. 4A and B each depict yet other time diagrams of LED driving values;

FIG. 5 depicts still another time diagram of setpoint values and LED driving values;

FIGS. 6A and 6B depict a schematic view of a configuration for video image capturing; and

FIG. 7 depicts a time diagram in connection with the video image capturing in accordance with FIGS. 6A and 6B.

### DETAILED DESCRIPTION OF THE INVENTION

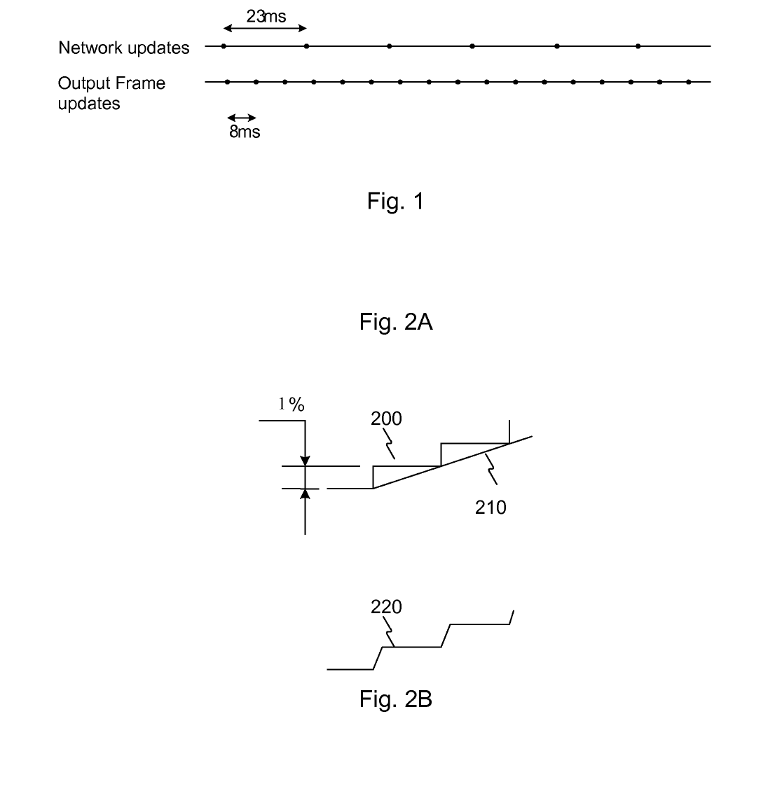

FIG. 1 depicts two horizontal lines which represent time lines. Dots on the lines represent data values as provided. A first one of the lines represents setpoint data that is provided, for example via a data network. In this example the setpoint data is provided periodically at a rate of every 23 ms. A second one of the lines represents LED driving values which are provided in this example at a data rate of every 8 ms.

In FIG. 2, signal 200 represents the set-point as sent by the external source, such as a master of a DMX communication bus. In the example as depicted, signal 200 represents a sequence of setpoints whose value increases with every setpoint, which is depicted in FIG. 2 as successive steps (as in between the increasing setpoints, no data is provided). To avoid visual effects at set-point amplitude step sizes of more than 1% of the current amplitude, the LED-current driven by the LED driver should ideally be changed in a continuous fashion from the previous set-point to the latest set-point according to a certain curve type, e.g. using a linear curve. Line 210 represents such ideal curve of the LED current, converted to a setpoint data domain to enable placing it in the same graph as the actually arriving set-points. The desired curve that resulted in the sequence of setpoints 200, would however more or less have resembled to smooth curve 210.

In accordance with prior art solutions, signal 220 is the practical LED current curve as produced by the LED-driver. Depending on the application and light levels, this may be far from ideal, as the 1% steps may still be present and thus visible in the signal and the light respectively.

In accordance with the invention, interpolation may be applied so as to enhance a resolution of the LED driving values.

As in signal 200 the amplitude steps as well as the delay between set-points is constant, a practical interpolator could easily learn its behaviour from the incoming stream of set-points. In the real world however, the amplitude steps nor the delays between set-points need to exhibit this regular behaviour. A very practical situation is for example the moment of reversing the direction of brightness change from increasing brightens to decreasing brightness and vice versa. A practical interpolator should be able to deal with such reversals and other irregularities without annoying the user by causing slow behaviour of wrong brightness.

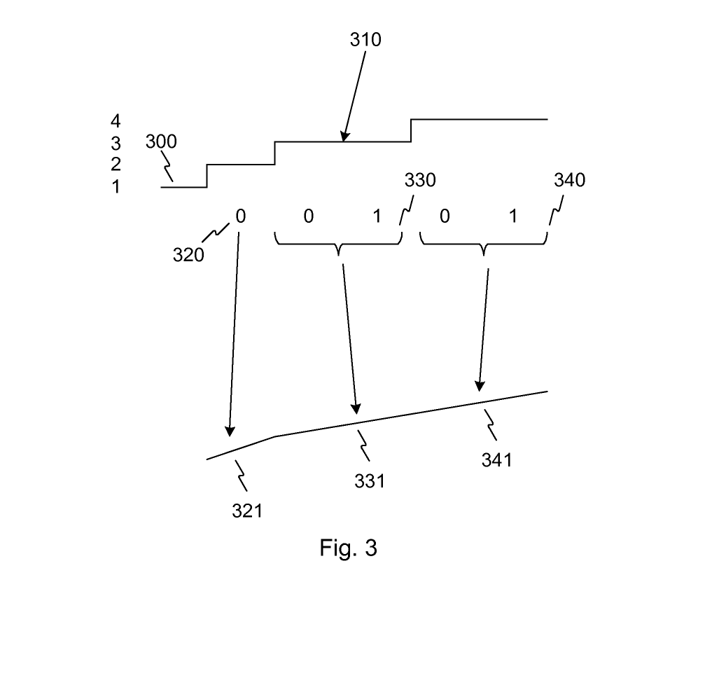

A method of interpolation an used in the invention will be explained with reference to FIG. 3.

As starting point, an interpolation is described whereby the LED driving value update rate is faster than the setpoint update rate. In this example, the practical figures presented in FIG. 1 are used.

Stepped curve 310 represents a sequence of 4 setpoint data values, the values being referred to in FIG. 3 as 1, 2, 3 and 4. The setpoint may in this example represent a sequence of values: 1 2 3 3 4 4. A time during which the same value is kept, is counted and represented by 320, 330 and 340. A slope may now be determined from the counting of the time that the setpoint data remains at the same value, and the difference between the setpoint value and the previous setpoint value. A possible slope is depicted as 321, 331 and 341. As the time between successive changes of the setpoint value at 330 and 340 is larger then 320, a rate of increase of the slope 331 and 341 is lower than of 321. LED driving values may now be determined along the slope.

In other words, as the network update (as an example of a providing of setpoint data) can be repetitive, as is indicated in FIGS. 1, 2 and 3. Thereby, it may be used as a time-base. A set-point data change occurs when the setpoint data value T in one of the repetitive transitions is different from its predecessor setpoint data value R. By counting (by counter 320, 330 340) a number of network setpoint data updates from the predecessor change to the latest change (a multiple of in this example 23 milliseconds) f.e. Nn*23 ms, the slope may be determined as it is the (T−R)/(N*23 ms) or (T−R)/Nn. Linear slopes may be applied as they may be calculated with little processing effort. The linear slopes result in a sharp bend between 321 and 331. A smoothness of the interpolated curve may further be enhanced by for example allowing only continuous changes, this making a derivative of the curve 321, 331, 341 to be continuous. This may for example be performed by a suitable filtering operation.

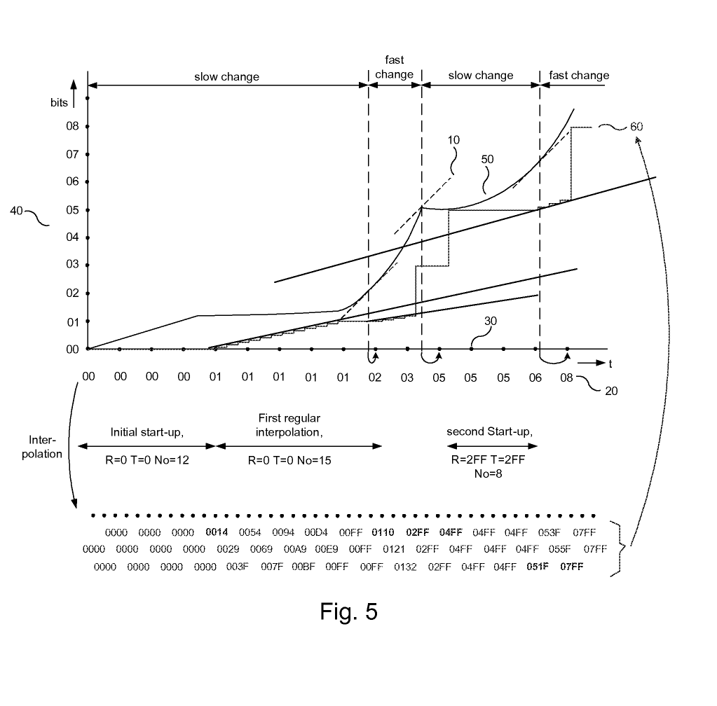

Reverting now to FIG. 5, another example will be described.

FIG. 5 depicts along horizontal time axis 30 a sequence of setpoint values 20 at equal time intervals there between. Vertical axis 40 depicts a value of the setpoints expressed in bits.

Before discussing FIG. 5 in more detail, a distinction between a fast change and a slow change is made. A distinction between fast and slow changes may be made at any suitable level: in this example a slow change is identified as a change of the setpoint values whereby a same value is maintained for two or more time periods of 23 ms. A fast change is in this example identified as a change of the setpoints whereby successive setpoints each have a different value. Therefore, in this example, two time zones of slow change and two time zones of fast change are identified. At a bottom part of FIG. 5, interpolated values are depicted. In this example, a resolution of the setpoint values is 8 bit, while a resolution of the LED driving values is 16 bit.

In the first slow regime slope of 12 increments is completely finished when next changed set-point (02 in this case) has not yet been received. Second slow regime slope of 15 increments has only gone 3 increments far when a new changed set-point arrives. Since this arrived within 1 network update time, a switch to fast regime is performed and new value is adopted immediately. Third slow regime slope of 8 increments has not yet been finished when setpoint with value 08 arrives, which is adopted immediately. The 3 slow regime slopes are all different, although this is barely visible.)

This will be explained using DMX at 512 channels per frame, each channel having 8 bits (40). This means that we will only observe a change when at least 1 bit is changed in the 8 bit set-point value in a channel. When the change is less than 1 bit per network set-point transmission (30) (“slow change”), then a number of the same set-points need to be transmitted before the set-point with plus or minus 1 bit value is transmitted (see 20 in FIG. 1). When receiving set-points that have the same value as their predecessor, no change slope can be calculated. Only when the set-point with the 1 bit extra or less is received, we will be able to calculate the slope. The slope will be (T−R)/No. In FIG. 5 this occurs for example when the set-point received is 0x01 (1 in hexadecimal form). Then T=0x01, R=0x00 and No=12 (counted in output-frame-updates) so that slope is 1/12. It has been explained that we will reach set-point T by incrementing from set-point R (or from the set-point belonging to the actual output) to T in No steps.

When on the other hand every set-point transmission a set-point is received with a value that differs 1 or more from the previous set-point (derivative of curve 50 is larger than ‘1 bit/network-update-time’ as indicated by lines 10), there is a substantial knowledge of the change rate, and a slope can be calculated with a reasonable correctness. This is called “fast change” in FIG. 0. Interpolation can be used in this case, but in 1 embodiment of the method according to the invention, no interpolation will be done on “fast changes”. When no interpolation is used, an error is made as the following example will show, but this error will be corrected automatically as soon as it becomes noticeable in the set-point value.

Example “fast mode”: Suppose the rate of change is 1.1 bit per 23 milliseconds. In that case we will receive for example the following sequence of set-points: 0 1 2 3 4 5 6 7 8 9 11 12 13 14 15 16 17 18 19 20 22 23 24 . . . .

As can be observed, the value between 11 and 9 differs by 2 and the same for 22 and 20. That is, after 10 updates, the rate of change causes 1 extra full bit to be added to the set-point value. Without using interpolation, the rate of change is 1/256 th of the full range, which is about 0.4% with an occasional correction of ( 2/256)th which is about 0.8% of full scale. These occasional double bit changes take place every 230 ms and are not observed as a discontinuity by the average human. This justifies not using interpolation on “fast changes”.

Or: the rate of change during 9 network updates is 1 which is 10% below actual. In the tenth update it is 2 which is 90% over actual.

In relative percentage versus the actual output, the change is: 0 infinite % 100% 50% 33% 25% 20% 17% 14% 12% 22% 9% 8% 7.7% 7% 6.6% etc. . . . .

Similar calculations on “slow changes”, for example with a rate of change of 0.1 bit every 23 milliseconds lead to the following example setpoint sequence: 0 0 0 0 0 0 0 0 0 0 1 1 1 1 1 1 1 1 1 1 2 2 2 2 2 2 2 2 2 2 3 3 3 3 3 3 3 3 3 3 4 4 4 . . . .

Here during 9 network updates the rate of change is 0 which is infinitely below the actual rate of change. Every tenth update, the change is 1 which is 1000% over actual. It is clear that interpolation will help smoothening the light output in this case.

In relative percentage versus the actual output, the change is: 0% 0% 0% 0% 0% 0% 0% 0% 0% 0% infinite % 0% 0% 0% 0% 0% 0% 0% 0% 0% 50% 0% 0% etc. . . . .

As the eye observes changes of 1%, an interpolator is needed here.

The processing of data may be performed by interpolation. Thereto, two approaches are described. In a first approach, which has basically been applied in the above description to FIG. 5, no prediction is applied. In a second approach, a historic trend of the received setpoint data is applied to predict a target value, whereby the interpolation is performed so as to let the LED driving values go towards the predicted target value.

In the first approach: Assume the system is continuously sending set-points at irregular delays but centered around a medium value of 23 ms and with a boundad deviation of + or −23 ms.

Assume an initial start-up has already been done and that the latest set-point sent is available in a target-set-point variable T and the set-point that was the predecessor of the latest is available in a reference-set-point R.

Assume also that the system counts the number of output updates since the reception of the last set-point in variable C and that this value is stored in N at each reception of a set-point.

Then the behaviour of the system between the reception of a set-point and the reception of the next set-point is as follows:

At reception of a set-point:

### R<=O

T<=new set-point

### N<=C

### C<=0

It is noted that the symbol <= is to be understood so as to express “becomes’, this A <=B is to be understood as A becomes B.

At “time passed to set new output”:

### O<=R+C*((T−R)/N)

note: O is the setpoint value for which the LED current is set. It is not the output current itself as typically there is a conversion factor involved between set-point and actual corresponding LED current.

### EXAMPLE

O1=50+1*((90−50)/3)=63,3

O2=50+2*((90−50)/3)=76,7

O3=50+3*((90−50)/3)=90

The first value of R, T, C and O after power up initialisation will be 0. This is representative for “no light” and in accordance with reality, so no odd start-up effect will be noticed. N can for example be set to 1. At reception of the first set-point it will be stored in T and due to N=1, the first non-zero output will be the full first set-point received. After that, the system functions according to the method.

A disadvantage to this system is that when a new set-point comes in a very long time after its predecessor, the amount of output updates to reach the new set-point will be high also. This causes a slow reaction of the system after a long setpointless period. Should a next new set-point be received before the N output updates are done (and so value T is not yet reached), the algorithm will catch up automatically because of the R<=O rule (which otherwise would have been R<=T rule).

In case the difference between the T and R is small immediately after rules “R<=O” and “T<=new set-point” have been executed, the system may decide to update the output in fewer steps in order to keep the system as responsive as possible. For example when the largest step not yet visible to the user is U, then the number of steps to update the output can be calculated as (R−O)/U. When N is larger then (R−O)/U, then (R−O)/U can be used in stead of N to update to the new set-point. After a long set-pointless period this is the fastest ramp-up to the new set-point that still produces smooth light.

When the output amplitude can be set at a much higher resolution (e.g. 16 bit) than that of the set-point values (e.g. 8 bit) and when the update rate is significantly higher than the setpoint reception frequency, the above system automatically creates internal setpoints at the much higher output resolution, causing a much smoother output than the set-point profile would lead to expect. In this way, in certain applications, set-points can even be packed to a lower amount of bits to either save on network bandwidth or to control more channels.

Note, when there is a large difference between the set-point rate and the output-update rate, the curve used to reach the next setpoint can be chosen to be linear, polynomial, spline, or over-under and critically damped (PID) etc.

This may lead to more attractive visual changes like for example a slow departure from the current brightness, gradually changing faster and faster until the new value is approached, and then slowing again further and further until the target value is reached.

Likely most applications do not need such a sophisticated curve, but some may. For example there may be industrial or bio-sciences applications where this is important.

In the second approach: The rate of change of the incoming set-points values can be measured.

The next set-point is then approached by generating intermediate internal set-points with a rate of value change equal to the first derivative of the most recent part of the set-point curve measured.

This method may be advantageous in systems where the output value corresponding to the set-point should be present immediately after the reception of that set-point, but at the same time set-point steps and set-point distances in time are such that a smooth continuous change of brightness is not possible.

When the corresponding output should be present immediately after the reception of that set-point, the delay involved in gradually growing towards an already received latest set-point as in the previous approach is not allowed.

In such a system, the driver will generate internal set-points that are predictive of the next set-point to be received. Light output will change gradually towards the value of the set-point to be received WHEN the new setpoint has the value given by the prediction. If not, an error will exist on the actual light output, that will be corrected immediately after receiving the latest set-point as it will immediately be used to set the output. Naturally, this approach will deliver errors when the value of the next set-point is wrong. These errors may cause sudden steps in the light output that may even prove to be larger than the set-point steps. When for example the direction in which the set-point values change is reversed, the approach will generate intermediate set-points in the wrong direction. As soon as the direction change is detected, this can be handled in a special way, for example by calculating the first derivative according to the line between the set-point corresponding to the actual output and the latest received set-point. This should lead to “catching up” with the actual rate of set-point change.

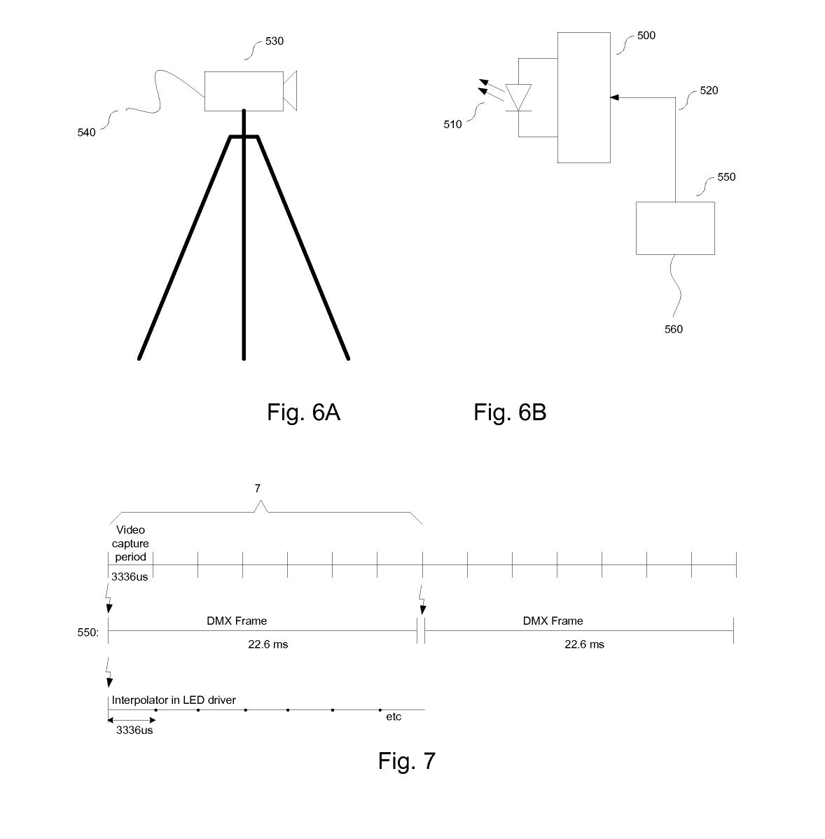

Reverting now to FIGS. 6A and 6B, a video camera 530 is shown that captures images of an LED 510 controlled by driver circuit 500 that is given setpoints from DMX network 520. The video camera 530 internally captures images at a rate of substantially 300 Hz (3336 μs per capture). Illustration of the timing is provided in the time diagram of FIG. 7.

In order for the camera to capture the LED at its true brightness, the LED duty cycle within the capture period should be equal to the overall duty cycle of the LED that causes the average brightness. This may advantageously be achieved by using a duty-cycle output frame that is smaller than the capture period of 3336 μs. This equals 300 Hz.

When the LED occupies more than 1 video line, this requirement can be relaxed, as the effect of multiple lines at different intensities averages out on screen. However, when the LED is only seen in 1 video line, intensity fluctuations will occur at these relaxed frequencies.

Since without further measures, the LED part and the camera part operate asynchronously, a LED intensity change may occur in the midst of a video capture, causing risk of erratic intensity behavior of the LED as observed in the video stream, in part depending on the current control algorithm used by the LED driver. To avoid this, it may be advantageous to update the LED's brightness and/or color at a rate that is a multiple of this 300 Hz. In view of the current state of the art in LED control, 300 Hz is chosen.

Furthermore it may be advantageous to synchronize such updates to the video capture rate to even further reduce visual effects of LED setpoint updates, especially in the case where multiple LEDs are used.

This synchronization may be done by coupling the internal video capture rate e.g. via connection 540 to the DMX master which in its turn provides a synchronous signal 520 to the driver. By deriving the output update rate from the interpolator in the driver from the DMX frame. e.g. by detecting the DMX breaks, LED updates are done in synch to the video capture rate. This reduces the visual effects of LED updates on screen. A typical application of this are TV-studio backgrounds in which LEDs are employed. In this controlled environment, a synchronization between camera part and LED part can be easily achieved.

In an embodiment, use is made of the control algorithm to control intensity of the LED as described in WO2006/107199. Output-frame updates may be the updates of a cycle time period of such algorithm, which may for example be 8192 μs. As can be seen, on average approximately 3 frame updates take place in the time it takes to update the network once. For high quality professional video applications, the output frame update time shall be 3336 us or less. As we will introduce syncing for video later in this embodiment, we will use 3336 us for the remainder of this embodiment. So we can count the amount of output-frame-updates between a previous set-point change and the latest set-point change. Let us name this No.

This approach is explained using figures from a practical example.

The practical example being a LED driver that is fed intensity set-points via DMX. The set-points are 8 bit wide and therefore fit in a DMX channel. The amount of DMX channels in a DMX frame is chosen to be 512. With these figures, 512 set-points can be transferred in 1 DMX universe which will take close to 23 milliseconds. In case more set-points are needed or in case 512 set-points are needed but with more bits per set-point, more DMX universes can be used in parallel in order to keep updating all set-points in 23 milliseconds. For example when a video display of 625 lines with 512 pixels per line is built up from a matrix of LEDs, then 625 DMX universes of 512 set-points of 8 bit will enable updating of the display in 23 milliseconds. During the reception of the 625 parallel DMX frames, the video display can be kept stable. At reception of the last set-point per frame the display can be updated in 1 instant. Total delay between image capture and display is then substantially 23 milliseconds.

On every output-frame-update (or faster), count the amount of network updates that have taken place (for each channel separately). As the output-frame update rate is higher than the network update rate, the count will be 0 or 1.

Then, time-next-set-point minus time-current-set-point equals:

(counter+1)*23 ms (network-update-time)/8 ms (frame-update-time)=4.

| counter | time-next-set-point |
|---|---|
| 0 | 3 |
| 1 | 6 |

This is used to make edges such as edges 321, 331 and 341 as depicted in FIG. 3.

It is remarked that other ways of interpolation, such as Bresnem line interpolation, may be used as well.

When the set-point changes fast enough, the above may provide adequate results. For slow changes however this may work less optimal. In case of slow changes, the counting may be done over a longer time period.

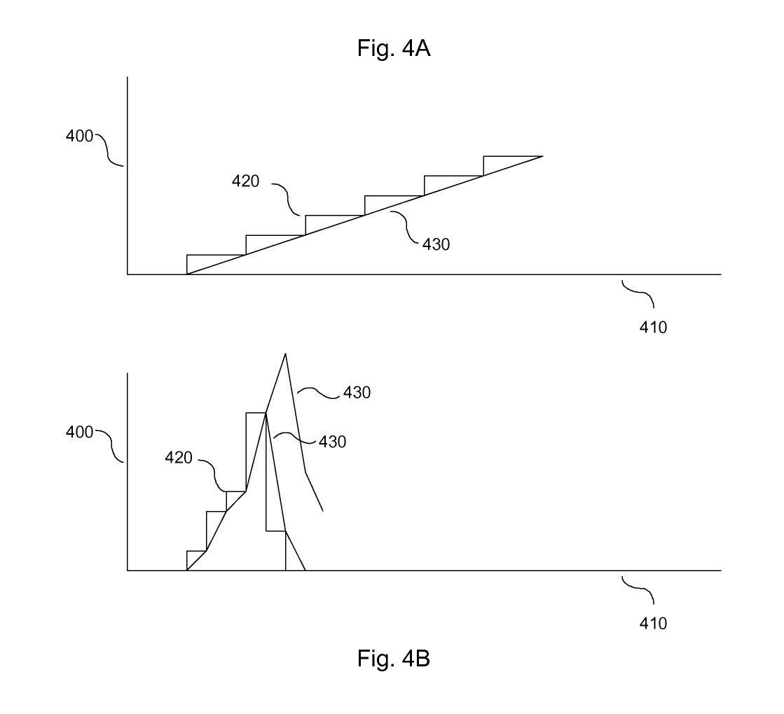

Note that the set-point interpolation is a prediction and therefore not absolutely correct. There may be deviations in the update rates and times, as well as in the set-point amplitude. An example is shown in FIGS. 4A and 4B. Where the interpolation of curve 430 in FIG. 4A from setpoints 420 behaves adequately, sudden changes—such as changes of direction—in setpoints 420 may result in the curve 430 continuing to develop in a “wrong” direction as a result of prediction. A network update rate (or time) may be measured and used to compensate errors with. Also the error between the actual used set-point and the actually sent set-point may be measured and the difference may be used to adjust the predicted set-points with, until the cumulative error is zero (integrator). Each new network update may then cause some error to be added to the cumulative error. At each frame update a part of the error may be used to heighten or lower the predicted set-points so that the cumulated error is continuously steered towards zero.

In daisy chained buses, the time delay between channels is substantially known and can be used to more accurately predict the interpolated set-points.

In video display systems using f.e. LEDs, a f.e. DMX frame may convey all set-points for 1 video line. However, everything on that videoline belongs to a video picture corresponding to 1 moment in time. The DMX transfer adds up to 23 ms of delay between the first video point and the last video point on the video line. This delay can be easily compensated using the proposed approach.

Frame alignment on the break of the DMX packet. (Break=88 us (or more) stable bus before a new frame is sent; So in fact the start of frame packet is used to sync on).

Based on some of the above described techniques, an example that provides a smooth dimming behavior over a wide range of applications is described below.

Assume that setpoint data is provided by means of a DMX bus and at a first data rate. The more different LED channels are to be driven by such DMX bus, the lower a data rate per channel. Assume that the data rate with which the setpoints for a particular LED channel are provided via the DMX bus, is lower than the data rate with which the LED driving values are provided to the LEDs and that the resolution of the LED driving values in generally higher than the resolution of the setpoint values,

As an example, setpoints are provided each 23 milliseconds, while the LED driving values are updated each 8 milliseconds.

A time between changes of the value of the setpoint data is measured. Thereto, the processing device is arranged to initialize a counter when a setpoint having a changed value is received, to periodically increment the counter so as to measure a the time, as long as the received setpoint data remains at the same value, and to store a value of the counter in a working memory of the processing device upon receipt of a setpoint data having a different value. Using the measured time during which the received setpoint data had the same value, and the value of the last received setpoint data, an interpolation slope is determined, for example in terms of an interpolation increment step size, the LED driving value then being interpolated (e.g. from its present value or from a previous setpoint) towards the new setpoint.

The incrementing of the counter of the elapsed time may be performed at each issue of a LED driving value, so that the time is measured in terms of the LED driving value data rate, which may be an accurate and stable data rate, made available by the driving circuit itself. The data rate with which the setpoints are received may be asynchronous with the data rate with which a light show has been set up or at a different sampling rate. For example, a light show may have been generated as a sequence of setpoints at a first data rate, while a characteristic of a databus that connects the LED driving circuit, requires a transmission of data at a second, different data rate, which may result in aliasing effects. Aliasing or like effects may be effectively reduced by an averaging of received setpoint data, prior to the interpolation of the (thus averaged) setpoint data. The interpolation thus being performed using the averaged setpoint data. Any type of averaging may be applied, for example a moving average filter. In an embodiment, the averaging comprises averaging the received setpoint data and one previously received setpoint data: hence, an effective averaging may be performed (which may effectively suppress aliasing effects in the setpoint data) while at the same time having a low impact on processing capacity of the processing device and on a dynamic behavior of the obtained LED intensity profile (light show) over time.

The processing device may be arranged to compare a difference between the received setpoint data and the previously received setpoint data with a predetermined threshold and in case the difference exceeds the threshold, to interpolate the LED driving value from its present value to a value corresponding with the received setpoint data in a time period substantially equal to the time period between receipt of two successive setpoint data.

Thereby, in case of large or relatively fast changes, instead of applying the measured, counted time value, the LED driving value is interpolated to the new setpoint within a shorter time, allowing to quickly follow the received setpoint values in a situation where additional interpolation steps would hardly or not be noticeable to a human observer.

Furthermore, in case of a slow change, whereby the processing device detects that a predetermined number of successive setpoint data has a same value, i.e. the processing device being arranged to, if the elapsed time measurement value exceeds a predetermined maximum value, upon receipt of an incremented or decremented setpoint data following successive setpoint data having the same value, store in the memory the predetermined maximum value in stead of the elapsed time measurement value, and interpolate the LED driving value to a value corresponding with the incremented or decremented setpoint data within a time period derived from the predetermined maximum value.

As a human eye may be relatively insensitive to a slow speed of change of small increments or decrements, an added benefit of an extremely slow, gradual rise may be little or none at all, hence may be avoided in such cases, by setting a limit to the time within which the driver circuit interpolates to the new setpoint.

It is noted that with the above described adaptive, smooth interpolation, a wide variety of operating conditions (fast or slow setpoint data rate, fast or slow increments, etc.) may be handled, Hence, little or no configuration parameters are to be set in order to provide an adequate, smooth dimming behavior. In particular when the averaging of (two) setpoint values is applied as described above, it may for example suffice to enable or disable the interpolation by a suitable configuration parameter.

An example of the above is described below:

Assume a fade is to be obtained in a time span of 10 seconds. Assume a time between setpoints of 80 ms (inter-setpoint time), namely 23 ms plus a waiting time of 57 ms. Th setpoints are coded with 8 bit resolution, the LED driving values are coded with a 16 bit resolution. A value of the first setpoint is 1 at 80 ms, a value of the second setpoint is 2 at 160 ms, etc. Assume that the LED is driven with an update rate of 8 milliseconds. A value of 10 is then measured between receipt of successive, changed setpoint values.

The LED is then driven during a following time period of 80 milliseconds with a sequence of 10 LED driving values (LDV):

| Time: | 80 | 88 | 96 | 104 | 112 | 120 | 128 | 136 | 144 | 152 | 160 |
|---|---|---|---|---|---|---|---|---|---|---|---|
| LDV: | 255 | 281 | 307 | 332 | 358 | 383 | 409 | 435 | 460 | 486 | 511 |
| Increment | ? | 26 | 26 | 25 | 26 | 25 | 26 | 26 | 25 | 26 | 25 |

In case however 11 LED driving values are detected between the two successive setpoints, the 256 steps in a 16 bit LED driving value resolution are divided by 11 obtaining 256/11=23,3, rounded to 23 which each 3 increments a value of 24, providing:

| Time | 80 | 88 | 96 | 104 | 112 | 120 | 128 | 136 | 144 | 152 | 160 | 168 |
|---|---|---|---|---|---|---|---|---|---|---|---|---|
| LDV: | 255 | 278 | 301 | 324 | 348 | 371 | 394 | 417 | 441 | 464 | 487 | 511 |
| Increment: | ? | 23 | 23 | 23 | 24 | 23 | 23 | 23 | 24 | 23 | 23 | 24 |

The algorithm is thus adaptive for differences in time between setpoints, for differences in setpoint values and for differences in LED driving value output rate.

1. A driver circuit for driving at least one LED, the driver circuit comprising:
a data input for receiving set point data at a first data rate and at a first bit resolution,
an LED output for driving the at least one LED with LED driving values at a second data rate and at a second bit resolution, and
a processing device arranged for determining from the set point data by interpolation at least part of the LED driving values.

2. The driver circuit according to claim 1, wherein the second data rate is higher than the first data rate, the processing device being arranged to interpolate in time.

3. The driver circuit according to claim 1, wherein the second bit resolution is higher than the first bit resolution, the processing device being arranged to interpolate in bit resolution.

4. The driver circuit according to claim 1, wherein the processing device is arranged to, in response to a receiving of a setpoint data, determine a target driving value from the received setpoint data, to determine a slope from the received setpoint data, a previous setpoint data, and an elapsed time between the received setpoint data and the previous setpoint data, and to determine following LED driving values in accordance with the slope and the target driving value.

5. The driver circuit according to claim 4, wherein the processing device is arranged to determine the target driving value in correspondence with the set point data.

6. The driver circuit according to claim 4, wherein the processing device is arranged to determine the following LED driving values so as to follow the slope towards the target driving value.

7. The driver circuit according to any of claim 4, wherein, the processing device is arranged to further determine if the slope exceeds a predetermined threshold, and if this is the case, to set a next following driving value to the target driving value.

8. The driver circuit according to any of claim 4, wherein the processing device is arranged to, when a following setpoint data is received at the data input before the target driving value has been reached, to determine a following target driving value from the following setpoint data, to determine a following slope from the following target driving value, a presently reached LED driving value and an elapsed time between the following setpoint data and the received setpoint data, and to determine following LED driving values in accordance with the following slope towards the following target driving value.

9. The driver circuit according to claim 1, wherein the processing device is arranged to, in response to the receiving of the setpoint data, predict the target driving value from the received setpoint data and at least one previously received setpoint data, and to determine following LED driving values in accordance with the predicted target driving value.

10. The driver circuit according to claim 9, wherein the predicting comprises a linear prediction.

11. The driver circuit according to claim 9, wherein the predicting comprises a finite impulse response filter prediction.

12. The driver circuit according to claim 1, wherein the processing device is arranged to detect if a direction of a value of a latest received setpoint data changes in respect of a direction of values of previously received successive setpoint data, and if this is the case, to calculate the target value from the latest received setpoint data and to interpolate along a line between an actual led driving value and the target value.

13. The driver circuit according to claim 9, wherein the processing device is arranged to set the target driving value between the target driving value as determined from the predicting and the target driving value as determined in correspondence with the received setpoint data.

14. The driver circuit according to claim 1, wherein the processing device is arranged to:
compare a value of a received setpoint with a value of a previously received setpoint,
increment an elapsed time measurement counter when the value of the received setpoint is the same as the value of the previously received setpoint,
repeat the compare and increment until the value of the received setpoint is different from the value of the previously received setpoint,
store a value of the elapsed time measurement counter in a memory of the processing device,
determine an interpolation slope from the received setpoint data and the value of the elapsed time measurement counter as stored in the memory, and
interpolate following LED driving values in accordance with the slope.

15. The driver circuit according to claim 14, wherein the processing device is arranged to increment the elapsed time measurement counter upon each issue of a LED driving value.

16. The driver circuit according to claim 1, wherein the processing device is arranged for averaging of received setpoint data, prior to the interpolation of the setpoint data.

17. The driver circuit according to claim 16, wherein the averaging comprises determining an average of the received setpoint data and one previously received setpoint data.

18. The driver circuit according to claim 1, wherein the processing device is arranged to compare a difference between the received setpoint data and the previously received setpoint data with a predetermined threshold and in case the difference exceeds the threshold, to interpolate the LED driving value from its present value to a value corresponding with the received setpoint data in a time period substantially equal to the time period between receipt of two successive setpoint data.

19. The driver circuit according to claim 14, wherein the processing device is arranged to, if the value of the elapsed time measurement counter exceeds a predetermined maximum value, upon receipt of an incremented or decremented setpoint data following successive setpoint data having the same value, store in the memory the predetermined maximum value in stead of the value of the elapsed time measurement counter, and interpolate the LED driving value to a value corresponding with the incremented or decremented setpoint data within a time period derived from the predetermined maximum value.

20. The driver circuit according to claim 14, wherein the processing device is arranged to enable or disable the interpolation upon receipt of a suitable configuration parameter data.

21. The driver circuit according to claim 1, wherein the processing device is arranged to set the second data rate to a video image capture rate or an integer multiple thereof.

22. A LED light fixture comprising the driver circuit in accordance with claim 1.

23. A method for driving at least one LED, comprising:
receiving by a data input of a driver circuit, set point data at a first data rate and at a first bit resolution,
driving by means of an LED output of the driver circuit the at least one LED with LED driving values at a second data rate and at a second bit resolution, and
wherein at least part of the LED driving values is determined from the set point data by interpolation by a processing device of the driver circuit.
